(19) United States
(12) Patent Application Publication
(10) Pub. No.: US 2025/0244510 A1
(43) Pub. Date: Jul. 31, 2025

(54) MANUFACTURING METHOD, MANUFACTURING DEVICE OF MULTI-LAYER METALENS AND MULTI-LAYER METALENS

(71) Applicant: HUZHOU METALENX TECHNOLOGY CO.,LTD, Zhejiang (CN)

(72) Inventors: Jian ZHU, Zhejiang (CN); Chenglong HAO, Zhejiang (CN); Fengze TAN, Zhejiang (CN)

(73) Assignee: HUZHOU METALENX TECHNOLOGY CO.,LTD, Zhejiang (CN)

(21) Appl. No.: 19/021,105

(22) Filed: Jan. 14, 2025

(30) Foreign Application Priority Data
Jan. 29, 2024 (CN) 202410115266.4

(51) Int. Cl. G02B 3/00; B29D 11/00; B82Y 20/00; B82Y 40/00; G02B 1/00

(52) U.S. Cl. CPC G02B 3/0075; B29D 11/00346; B82Y 20/00; B82Y 40/00; G02B 1/002; G02B 3/0068

(57) ABSTRACT

A manufacturing method, manufacturing device, a multi-layer metalens are provided. The the multi-layer metalens comprises a plurality of N structured surfaces arranged in a vertical direction on one surface of a wafer, N≥2. The manufacturing method includes: when a target surface to be manufactured is a first structured surface, manufacturing the first structured surface on a target surface of the wafer; the first structured surface includes a plurality of nanostructures and a location marker; and the plurality of nanostructures are arranged in an array; when the target surface to be manufactured is an Mₜₕ structured surface, manufacturing an alignment window based on the location marker of the structured surface manufactured previously; and through the alignment window, manufacturing the Mₜₕ structured surface based on the location marker of the structured surface manufactured previously.

### CROSS-REFERENCE TO RELATED APPLICATION

This application claims the benefit of priority from Chinese Patent Application No. 202410115266.4, filed on Jan. 29, 2024. The content of the aforementioned application, including any intervening amendments thereto, is incorporated herein by reference in its entirety.

### TECHNICAL FIELD

The present disclosure relates to the field of lenses, in particular to a manufacturing method, a manufacturing device of a multi-layer metalens and a multi-layer metalens.

### BACKGROUND

A multi-layer metalens is a kind of metalens that has multiple structured surfaces set on the substrate in order in a vertical direction with respect to the substrate. According to the design requirements of the application, the distortion curve of the nanostructures in each structured surface can be modulated, respectively, therefore the nanostructure database can be enriched effectively, which will be beneficial to match with the phase curve of a wide spectrum based on the design requirements of the application. Compared with single-layer metalens, the multi-layer metalens can provide a wider range of phase coverage and dispersion curve modulation, which is more suitable for all kinds of wide-spectrum modulation application scenarios.

It should be noted that to meet the expected optical performance of the multi-layer metalens, it is necessary to control the relative positions between the arrays in different structured surfaces accurately. However, the relevant technology does not provide a technical scheme for the accurate control of the relative positions between the nanostructure arrays in different structured surfaces.

### SUMMARY

In view of the above technical problems, a manufacturing method, a device of a multi-layer metalens and a multi-layer metalens are provided according to embodiments of the present disclosure, so as to overcome the problems in the related art.

In the first aspect, a manufacturing method of a multi-layer metalens is provided, wherein the multi-layer metalens includes a plurality of N structured surfaces arranged in a vertical direction on one surface of a wafer, N≥2;

the manufacturing method includes:

when a target surface to be manufactured is a first structured surface, manufacturing the first structured surface on a target surface of the wafer; the first structured surface comprises a plurality of nanostructures and a location marker; and the plurality of nanostructures are arranged in an array;

when the target surface to be manufactured is an Mₜₕ structured surface, manufacturing an alignment window based on the location marker of the structured surface manufactured previously; and through the alignment window, manufacturing the Mₜₕ structured surface based on the location marker of the structured surface manufactured previously;

wherein the Mₜₕ structured surface includes a plurality of nanostructures; and the plurality of nanostructures are arranged in an array;

a position of the array of nanostructures in the Mₜₕ structured surface matches with a position of the array of nanostructures in the structured surface manufactured previously in a perpendicular direction; M≤N, and M>1.

In one embodiment, “manufacturing an alignment window based on the location marker of the structured surface manufactured previously” includes:

manufacturing the alignment window based on the location marker of the first structured surface; wherein a projection of the location marker of the first structured surface on a parallel surface of the wafer is located inside a projection of the alignment window on a parallel surface of the wafer;

“through the alignment window, manufacturing the Mₜₕ structured surface based on the location marker of the structured surface manufactured previously” includes: through the alignment window, manufacturing the Mₜₕ structured surface based on the location marker of the first structured surface.

In one embodiment, “manufacturing the alignment window based on the location marker of the structured surface manufactured previously” comprises:

manufacturing the alignment window of the Mₜₕ structured surface based on the location marker of the M−1ₜₕ structured surface; wherein a projection of the location marker of the M−1ₜₕ structured surface on a parallel surface of the wafer is located inside a projection of the alignment window on a parallel surface of the wafer;

“through the alignment window, manufacturing the Mₜₕ structured surface based on the location marker of the structured surface manufactured previously” includes: through the alignment window, manufacturing the Mₜₕ structured surface based on the location marker of the M−1ₜₕ structured surface; wherein, when M<N, the Mₜₕ structured surface further comprises a location marker.

In one embodiment, the projections of the location markers of the structured surfaces on the parallel surface of the wafer don't overlap with each other.

In one embodiment, “manufacturing the first structured surface on a target surface of the wafer” includes:

manufacturing a first structured layer on the target surface, and lithographing and etching the first structured layer, so as to obtain the array of nanostructures and the location marker on the target surface;

filling a first filler material between the adjacent nanostructures, and between the nanostructures and the location marker on the target surface to obtain the first structured surface.

In one embodiment, “manufacturing an alignment window based on the location marker of the structured surface manufactured previously” includes:

manufacturing an Mₜₕ structured layer on the upper surface on the M−1ₜₕ structured surface, and lithographing and etching the Mₜₕ structured layer to obtain the alignment window;

“through the alignment window, manufacturing the Mₜₕ structured surface based on the location marker of the structured surface manufactured previously” includes:

through the alignment window, pre-locating the array of nanostructures to be manufactured in the Mₜₕ structured layer based on the location marker of structured surface manufactured previously;

based on the pre-location of the array of nanostructures in the Mₜₕ structured surface, lithographing and etching the Mₜₕ structured layer, so as to obtain the array of nanostructures on the upper surface of the M−1ₜₕ structured surface;

filling an Mₜₕ filler material between the arrays of nanostructures on the upper surface of the M−1ₜₕ structured surface, so as to obtain the Mₜₕ structured surface.

In one embodiment, after filling a filler material to obtain the corresponding structured surface, the manufacturing method includes:

thinning and polishing an upper surface of the obtained corresponding structured surface.

In one embodiment, after lithographing and etching the structured layer, the obtained nanostructures on the structured layer are positive nanostructures.

In one embodiment, after lithographing and etching the structured layer, the obtained nanostructures in the structured layer are negative nanostructures.

In the second aspect, a manufacturing device is provided, wherein the multi-layer metalens includes an N structured surfaces arranged in a vertical direction on the same surface of a wafer, N≥2;

a manufacturing module of the first structured surface, the manufacturing module of the first structured surface is configured to manufacture the first structured surface on a target surface of the wafer, when the target surface to be manufactured is the first structured surface; wherein the first structured surface comprises the array of nanostructures and location marker;

a manufacturing module of the Mₜₕ structured surface, the manufacturing module of the Mₜₕ structured surface is configured to manufacture an alignment window based on the location marker of the structured surface manufactured previously; and through the alignment window, to manufacture the Mₜₕ structured surface based on the location marker of the structured surface manufactured previously; the Mₜₕ structured surface comprises a plurality of nanostructures, and the plurality of nanostructures are arranged in an array; a position of the array of nanostructures in the Mₜₕ structured surface matches with a position of the array of nanostructures in the M−1ₜₕ structured surface in the perpendicular direction; M≤N, and M>1.

In the third aspect, a multi-layer metalens is provided, wherein the multi-layer metalens is obtained by using the manufacturing method.

In one embodiment, the multi-layer metalens includes an N structured surfaces arranged in a vertical direction on the same surface of a wafer, N≥2;

the N structured surfaces include: the first structured surface, the second layer, . . . , the Nₜₕ structured surface; the first structured surface comprises the plurality of nanostructures and the location marker, and the plurality of nanostructures are arranged in an array;

the Mₜₕ structured surface includes an alignment window, and the alignment window corresponds to the location marker of the structured surface manufactured previously;

the Mₜₕ structured surface includes a plurality of nanostructures, and the plurality of nanostructures are arranged in an array;

a position of the array of nanostructures in the Mₜₕ structured surface matches with a position of the array of nanostructures in the M−1ₜₕ structured surface in a perpendicular direction; M≤N, and M>1.

In one embodiment, a projection of the location marker of the structured surface manufactured previously on a parallel surface of the wafer is located inside a projection of the alignment window in the structured surface manufactured previously on a parallel surface of the wafer.

In one embodiment, a projection of the location marker of the structured surface manufactured previously on a parallel surface of the wafer is located inside a projection of the alignment window in the structured surface manufactured previously on a parallel surface of the wafer;

wherein, when M<N, the Mₜₕ structured surface further includes a location marker.

In one embodiment, the projections of the location markers in the structured surfaces on the parallel surface of the wafer don't overlap with each other.

In the fourth aspect, an electronic device is provided, and the electronic device includes: a bus, a transceiver, a memory, a processor and a computer program;

wherein the computer program is stored in the memory and executable on the processor; the transceiver, the memory and the processor are connected through the bus; the computer program is executed by the processor, so as to implement the manufacturing method.

In the fifth aspect, a non-transitory computer-readable storage medium is provided, and the non-transitory computer-readable storage medium in which a computer program is stored, wherein the computer program is executed by a processor, so as to implement the manufacturing method.

In the present application, the multi-layer metalens includes N structured surfaces along the vertical direction on one surface of the wafer, and N≥2. When the target surface to be manufactured is a first structured surface, the first structured surface is manufactured on a target surface of the wafer; and the first structured surface includes a plurality of nanostructures and a location marker; and the plurality of nanostructures are arranged in an array. When the target surface to be manufactured is an Mₜₕ structured surface, an alignment window is manufactured based on the location marker of the structured surface manufactured previously; and through the alignment window, the Mₜₕ structured surface is manufactured based on the location marker of the structured surface manufactured previously; wherein the Mₜₕ structured surface includes a plurality of nanostructures; and the plurality of nanostructures are arranged in an array; the position of the array of nanostructures in the Mₜₕ structured surface matches with the position of the array of nanostructures in the structured surface manufactured previously in the perpendicular direction; M≤N, and M>1. The manufactured method provided by the present application matches the position of array of nanostructures of Mₜₕ structured surface with the position of array of nanostructures of the structured surfaces manufactured previously, thus controlling the relative positions accurately.

Other features and advantages of the present application will become apparent by the detailed description below, or in part by the practice of the present application.

It should be understood that the above general description and detailed details are exemplary only, and do not limit this application.

### BRIEF DESCRIPTION OF THE DRAWINGS

In order to explain more clearly, the technical scheme in the application technology or the background technology, the attached drawings required in the application embodiment or the background technology will be explained below.

FIG. 1 shows a structural diagram of the multi-layer metalens provided by the present application.

FIG. 2 shows a flowchart of the manufacturing method of a multi-layer metalens provided by the present application.

FIG. 3 shows a structural diagram of an obtained structure after the first structured layer being manufactured on the target surface of the wafer.

FIG. 4 shows a structural diagram of an array of nanostructures and the location marker after lithographing the first structured layer.

FIG. 5 shows a structural diagram of the array of nanostructures and the location marker after etching the first structured layer in one embodiment.

FIG. 6 shows a structural diagram of the first structured surface after filling the first filler material between the array of nanostructures of the location marker.

FIG. 7 shows a structural diagram of a structured surface after thinning and polishing the upper surface of the first structured surface.

FIG. 8 shows a schematic diagram of the obtained structure after manufacturing the second structured layer on the upper surface of the first structured surface.

FIG. 9 shows a schematic diagram of the obtained structure after lithographing the second structured layer to manufacture an alignment window in an embodiment of the present application.

FIG. 10 shows a schematic diagram of the obtained structure after etching the second structured layer to manufacture the alignment window in an embodiment of this application.

FIG. 11 shows a schematic diagram of the obtained structure after lithographing the second structured layer to manufacture an array of nanostructures in an embodiment of this application.

FIG. 12 shows a schematic diagram of the obtained structure after etching the second structured layer to manufacture the array of nanostructures in an embodiment of this application.

FIG. 13 shows a schematic diagram of the obtained second layer after filling the second filler material between the array of nanostructures located on the upper surface of the first structured surface.

FIG. 14 shows a schematic diagram of the obtained structure after thinning and polishing the upper surface of the second structured surface in an embodiment of this application.

FIG. 15 shows a schematic diagram of the obtained structure after the lithography of the array of negative nanostructures in the first structured layer.

FIG. 16 shows a schematic diagram of the obtained structure after etching the array of negative nanostructures in the first structured layer.

FIG. 17 shows a schematic diagram of the obtained structure after etching of array of negative nanostructures in the second structured layer.

FIG. 18 shows a schematic diagram of the obtained structure after lithographing of array of negative nanostructures in the second structured layer.

FIG. 19 shows a schematic diagram of the obtained structure after filling the second filler material in the array of negative nanostructures.

FIG. 20 shows a schematic diagram of the obtained structure after thinning and polishing the array of negative nanostructures on the upper surface of the second structured surface.

FIG. 21 shows a top view of the first structured surface provided by the present application.

FIG. 22 shows a top view of the second structured surface provided by the present application.

FIG. 23 shows a block diagram of a manufacturing device for a multi-layer metalens provided in the present application.

### DETAILED DESCRIPTION OF DISCLOSURED EMBODIMENTS

An embodiment will be described in detail below, the examples of which are represented in the accompanying drawings. When the following description involves the drawings, the same numbers in different drawings indicate the same or similar elements unless otherwise indicated. The embodiments described in the following exemplary embodiment do not represent all embodiments consistent with the present disclosure. Instead, they are only examples of devices and methods consistent with some aspects of the present disclosure, as detailed in the attached claim.

Furthermore, the described features, structures or features may be combined in one or more exemplary embodiments in any suitable manner. In the following description, many specific details are provided to give a full understanding of the exemplary embodiments of this application. However, those skilled in the art will be aware that the technical solution of the present application may be practiced to omit one or more of the specific details described, or that other methods, groups, steps, and the like may be adopted. In other cases, aspects of the present application are blurred without detailed showing or describing the public structure, method, implementation, or operation to avoid over-dominance.

Some of the box plots shown in the accompanying drawings are functional entities and do not necessarily have to correspond to physically or logically separate entities. These functional entities can be implemented in the form of software, or in one or more hardware modules or integrated circuits, or in different networks and/or processor devices and/or micro-controller devices.

A manufacturing method of the multi-layer metalens is provided by the present application, when manufacturing a multi-layer metalens by the manufacturing method provided by the present application, the relative position between the array of nanostructures in different structured surfaces can be controlled accurately.

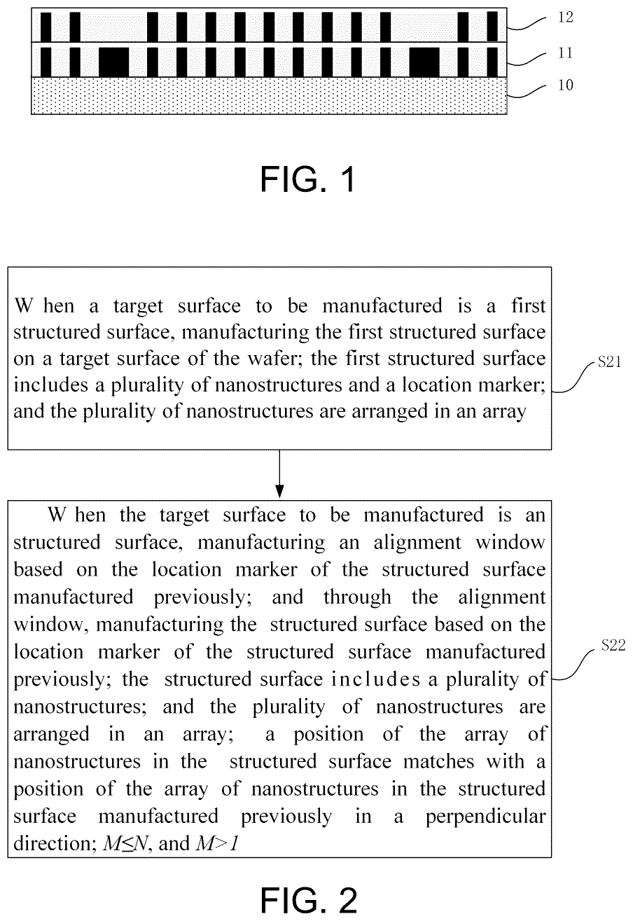

In detail, FIG. 1 shows a structural diagram of the multi-layer metalens provided by the present application. In one embodiment, the multi-layer metalens provided by the present embodiment is mainly used at a visible waveband or a near-infrared waveband. In this situation, the wafer 10 may be made of transparent material at the visible waveband or the near-infrared waveband. For example, the wafer may be made of quartz that has a smaller optical absorption at the visible waveband and the near-infrared waveband.

Further, in the present application, on one surface of the wafer 10, the multi-layer metalens includes a plurality of N structured surfaces arranged in a vertical direction on one surface of a wafer, N≥2. FIG. 1 shows a multi-layer metalens with the first structured surface and the second structured surface (N=2). However, it doesn't mean that the multi-layer metalens manufactured by the manufacturing method provided in this application can only have two structured surfaces.

FIG. 2 shows a flowchart of the manufacturing method of a multi-layer metalens provided by the present application. As shown in FIG. 2, the manufacturing method provided in this application includes:

S21. when the target surface to be manufactured is a first structured surface, manufacturing the first structured surface on a target surface of the wafer; the first structured surface includes a plurality of nanostructures and a location marker; and the plurality of nanostructures are arranged in an array;

S22. when the target surface to be manufactured is an Mₜₕ structured surface, manufacturing an alignment window based on the location marker of the structured surface manufactured previously; and through the alignment window, manufacturing the Mₜₕ structured surface based on the location marker of the structured surface manufactured previously; wherein the Mₜₕ structured surface includes a plurality of nanostructures; and the plurality of nanostructures are arranged in an array; and the position of the array of nanostructures in the Mₜₕ structured surface matches with the position of the array of nanostructures in the structured surface manufactured previously in the perpendicular direction; M≤N, and M>1.

Specifically, in the present application, the structured surfaces of the multi-layer metalens are divided into the first structured surface 11 and the Mₜₕ structured surface. The Mₜₕ structured surface is a structured surface to be manufactured after the first structured surface 11 has been manufactured.

When the target surface to be manufactured is a first structured surface, the first structured surface including the array of nanostructures and the location marker is manufactured on the target surface of the wafer. The location marker of the first structured surface 11 is capable of providing a location reference for the array of nanostructures in the Mₜₕ structured surface.

When the target surface to be manufactured is an Mₜₕ structured surface, an alignment window is manufactured based on the location marker of the structured surface manufactured previously. The alignment window is capable of exposing the location marker of the structured surface manufactured previously within the detection range at a specific waveband. Therefore, through the alignment window, the array of nanostructures of the Mₜₕ structured surface is pre-located accurately to manufacture based on the location markers in the structured surfaces manufactured previously and obtain the Mₜₕ structured surface. In this way, the position of the array of nanostructures in the Mₜₕ structured surface matches with the position of the array of nanostructures in the structured surface manufactured previously.

It should be noted that for the Mₜₕ structured surface, the structured surface manufactured previously may be the first structured surface 11 or the M−1ₜₕ structured surface. For example, for the third structured surface, the structured surface manufactured previously may be the first structured surface 11, or the the structured surface manufactured previously may be the second structured surface 12.

It also should be noted that “the position of array of nanostructures in the Mₜₕ structured surface matches with the position of the array of nanostructures in the structured surface manufactured previously” refers to for the Mₜₕ structured surface and the structured surface manufactured previously, the deviation of the projections of the array of nanostructures of those structured surfaces on the parallel surface of the wafer is equal to 0, or the deviation of the projections of the array of nanostructures of those structured surfaces on the parallel surface of the wafer is less than a pre-set position tolerance.

It can be seen that the manufacturing method provided by the present application the position of the array of nanostructures in the Mₜₕ structured surface matches with the position of the array of nanostructures in the structured surface manufactured previously. Therefore, the relative position between the array of nanostructures in the different structured surfaces can be controlled accurately.

In one embodiment, “manufacturing the first structured surface on a target surface of the wafer” includes:

manufacturing the first structured surface on the target surface, and lithographing and etching the first structured surface, so as to obtain the array of nanostructures and location marker on the target surface;

filling a first filler material between the nanostructures and the location marker on the target surface to obtain the first structured surface.

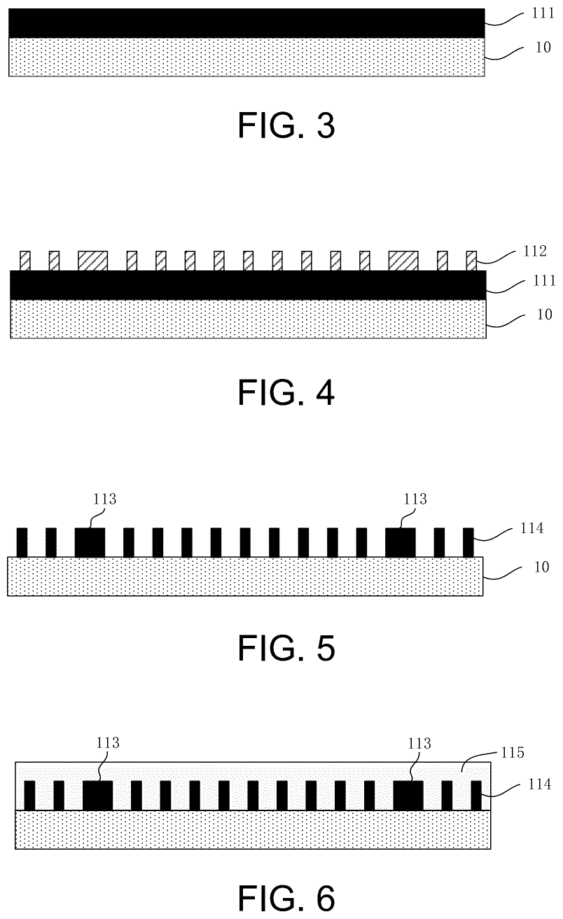

Specifically, FIG. 3 shows a structural diagram of an obtained structure after the first structured layer 111 is manufactured on the target surface of the wafer 10. FIG. 4 shows a structural diagram of an array of nanostructures 114 and the location marker 113 after lithographing the first structured layer 111. FIG. 5 shows a structural diagram of the array of nanostructures 114 and location marker 113 after etching the first structured layer 111 in one embodiment. FIG. 6 shows a structural diagram of the first structured surface in one embodiment after filling the first filler material between the array of nanostructures 114 of the location marker 113.

As shown from FIG. 3 to FIG. 6, in on embodiment, firstly the first structured layer 111 is manufactured on the target surface of the wafer 10. Then the photoresist 112 is coated to an upper surface of the first structured layer 111, and next the photoresist 112 is exposed and developed according to the distribution position of the array of nanostructures and the shape of nanostructures 114, and the distribution position and shape of the location marker 113. In this way, the pattern of the residual photoresist 112 will form the array of the nanostructures 114 obtained by the target (when the photoresist is a positive photoresist, the part of the exposure area is dissolved in the developing solution and the portion of the non-exposure area remains as the residual photoresist 112; when the photoresist is a negative photoresist, the portion of the non-exposure area remains as the residual photoresist 112), and the pattern of the location marker 113. The pattern of the array of the nanostructures 114 obtained by the target and the pattern of the location marker 113 are complementary patterns, or the pattern of the obtained array of the nanostructures 114 and the pattern of the location marker 113 are complementary patterns.

Then the portion exposing outside of the photoresist 112 of the first structured layer 111 is etched, so as to obtain the array of nanostructures 114 and location marker 113. Then the residual photoresist 112 is removed, and the first filler material 115 is filled between the array of nanostructures 114 and location marker 113, so as to obtain the first structured surface 11.

The first filler material 115 is used to protect the array of nanostructures 114 and location marker 113. The first filler material 115 is used to increase the transmittance of the first structured surface 11 for lights. And the first filler material 115 can provide the necessary support for the structured surface to be manufactured.

It should be noted that in the actual manufacturing process, when the structured layers are manufactured, different locations of the etching depth will have differences. It will leads to the heights of different nanostructures has a bit of difference. Although in the figures of the present application different nanostructures obtained by etching are neat and uniform, it should be understood that the figures are only used for example instructions and should not limit the scope of projection for the present application. In the present application, the sizes of different nanostructures obtained by etching are within a certain error range.

It should be noted that in the actual manufacturing process, after filling the filler material, the obtained structured surfaces are still uneven. Although in the figures provided by the present application, the upper surface of the structured surface after filling the filler material are even and smooth, it should be understood that the figures are only used for example instructions and should not limit the scope of projection for the present application. In the present application, the upper surface of the structured surface after filling the filler material may be uneven.

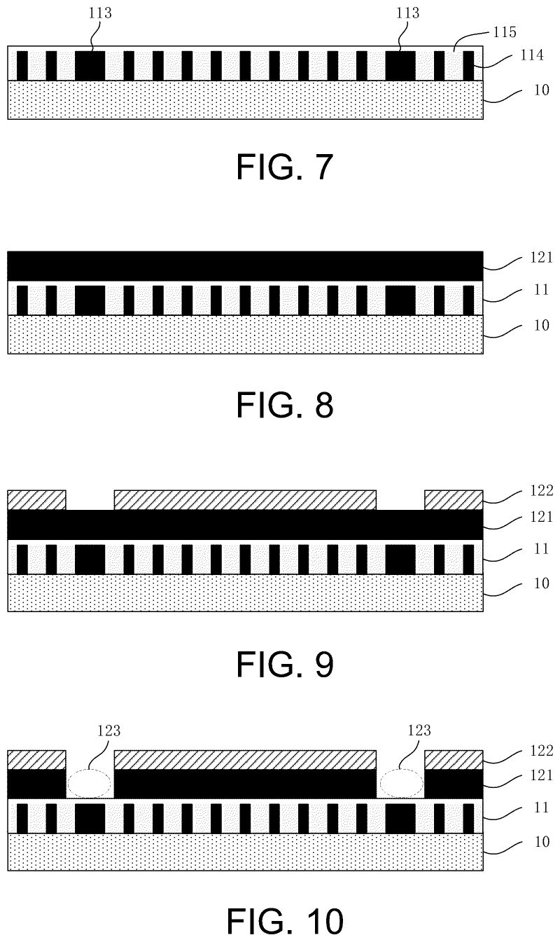

FIG. 7 shows a structural diagram of a structured surface after thinning and polishing the upper surface of the first structured surface. As shown in FIG. 7, in one embodiment, for the array of nanostructures 114 and location marker 113 of the first structured surface, after filling the first filler material 115, the upper surface of the first structured surface 11 is thinned and polished, so as to make the distance between the upper surface of the first structured surface 11 and the upper surface of the array of nanostructures 114 is less than a pre-set threshold. In this way, the upper surface of the first structured surface 11 has a high plainness.

When the target surface to be manufactured is the Mₜₕ structured layer, in one embodiment, “manufacturing an alignment window based on the location marker of the structured surface manufactured previously” includes:

manufacturing the Mₜₕ structured layer on the target surface on the M−1ₜₕ structured surface, and lithographing and etching the Mₜₕ structured layer to obtain the alignment window.

“through the alignment window, manufacturing the Mₜₕ structured surface based on the location marker of the structured surface manufactured previously” includes:

through the alignment window, pre-locating the array of nanostructures to be manufactured in the Mₜₕ structured layer based on the location marker of structured surface manufactured previously;

based on the pre-location of the array of nanostructures in the Mₜₕ structured surface, lithographing and etching the Mₜₕ structured layer, so as to obtain the array of nanostructures of the M−1ₜₕ structured surface;

filling an Mₜₕ filler material between the arrays of nanostructures on the upper surface of the M−1ₜₕ structured surface, so as to obtain the Mₜₕ structured surface.

Specifically, in one embodiment, when the Mₜₕ structured surface is manufactured, firstly the Mₜₕ structured layer is manufactured on the M−1ₜₕ structured surface, and then the photoresist is coated to the upper surface on the Mₜₕ structured layer. Then the photoresist is exposed and developed according to the distribution position and size of the alignment window obtained by the target, so that the pattern composed of the residual photoresist just constitutes the complementary pattern of the alignment window obtained by the target. Then, the part of the Mₜₕ structured layer exposed to the photoresist is etched to obtain the alignment window.

It should be understood that the alignment window obtained by the manufacturing method makes the upper surface of the M−1ₜₕ structured surface expose in the outside directly. Therefore, through the alignment window, the location marker of the structured surface manufactured previously can be located accurately. Then, based on the location marker of the structured surface manufactured previously, the array of nanostructures to be manufactured in the Mₜₕ structured layer can be pre-located accurately, and the distribution position of the array of nanostructures and the shape of nanostructures to be manufactured can be determined accurately.

Then according to the distribution position of the array of nanostructures and the shape of nanostructures to be manufactured, the photoresist is exposed and developed again, so that the pattern of the residual photoresist just constitutes the pattern of the array of nanostructures obtained by the target, or the complementary pattern of the array of nanostructures obtained by the target (if the area of the alignment window is excluded). Then the portion of the Mₜₕ structured layer exposing to the photoresist is etched, that is, an array of nanostructures located on the upper surface of the structured surface manufactured previously.

Then the residual photoresist is removed, and the Mₜₕ filler material is filled between the adjacent nanostructures on the M-1ₜₕ structured surface, and between the array of nanostructures and the location marker on the M−1ₜₕ structured surface, and the Mₜₕ structured surface is obtained.

Similar to the function of the first filler material 115, the function of the Mₜₕ filler material will not be described here.

It should be noted that the Mₜₕ filler material filled in the Mₜₕ structured surface may be the same material as the first filler material 115 filled in the first structured surface 11, or the Mₜₕ filler material filled in the Mₜₕ structured surface may be a different material from the first filler material 115 filled in the first structured surface 11.

It should also be noted that the Mₜₕ structured surface may be set with the location marker, or may not be set with the location marker. When the Mₜₕ structured surface needs to be set with a location marker, based on the location marker of the structured layer manufactured previously, the array of nanostructures in the Mₜₕ structured layer to be manufactured is pre-located. Thus, the position distribution of the array of nanostructures, the shape of the nanostructures and the location marker to be manufactured can be determined simultaneously. Therefore, according to the location distribution of the array of nanostructures to be manufactured and the shape of the location marker, after exposing and developing the photoresist, so that the pattern formed by the residual photoresist may be the pattern of the array of nanostructures and location marker, or may be a complementary pattern of the array of nanostructures and location marker (when the alignment window is excluded), therefore, the array of nanostructures located on the upper surface and the location marker on the structured surface manufactured previously is obtained by etching.

In one embodiment, for the array of the nanostructures in the Mₜₕ structured surface, after filling the Mₜₕ filler material, the upper surface of the Mₜₕ structured surface is thinned and polished, so as to ensure that the distance between the upper surface of the Mₜₕ structured surface and the upper surface of the array of nanostructures in the Mₜₕ structured surface is less than a pre-set threshold, thus the upper surface of the Mₜₕ structured surface has a high plainness.

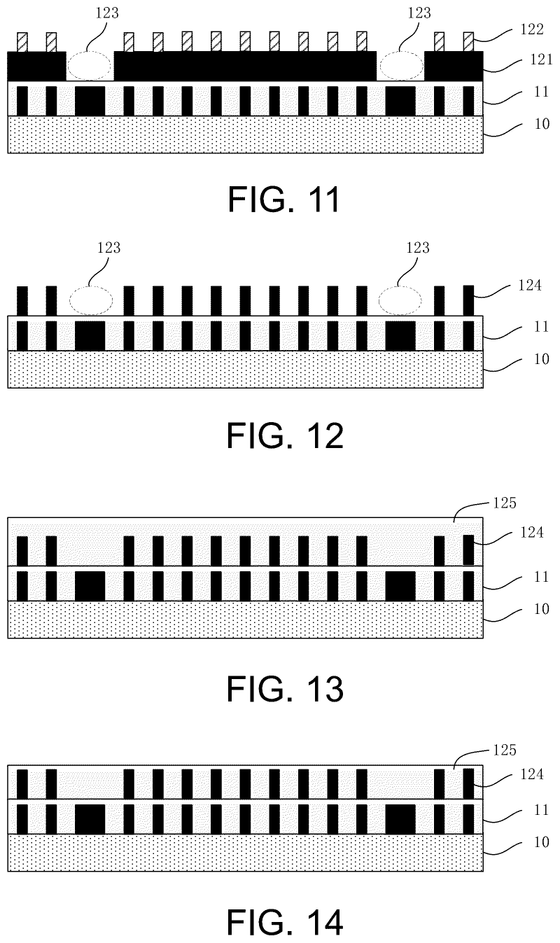

FIG. 8 shows a schematic diagram of the obtained structure after manufacturing the second structured layer 121 on the upper surface of the first structured surface 11. FIG. 9 shows a schematic diagram of the obtained structure after lithographing the second structured layer 122 to manufacture an alignment window in an embodiment of the present application. FIG. 10 shows a schematic diagram of the obtained structure after etching the second structured layer 122 to manufacture the alignment window 123 in an embodiment of this application. FIG. 11 shows a schematic diagram of the obtained structure after lithography of the second structured layer 122 to manufacture an array of nanostructures 124 in an embodiment of this application. FIG. 12 shows a schematic diagram of the obtained structure after etching the second structured layer 122 to manufacture the array of nanostructures 124 in an embodiment of this application. FIG. 13 shows a schematic diagram of the second layer of structure surface 12 after filling the second filler material 125 between the array of the nanostructures 124 located on the upper surface of the first structured surface 11.

As shown from FIG. 8 to FIG. 13, in one embodiment, when the second structured surface 12 is manufactured, firstly the second structured layer 121 is manufactured on the first structured surface 11, then the photoresist is coated to the upper surface of the second structured layer 121. According to the position distribution and size of the alignment window 123 obtained by the target, the photoresist is exposed and developed, so that the pattern of the residual photoresist 122 exactly forms a complementary pattern of the alignment window 123 obtained by the target. Then the alignment window 123 is obtained by etching the portion of the second structure layer 121 exposed outside the photoresist 122.

Therefore, through the alignment window 123, the location marker of the first structured surface 11 is located accurately. The array of nanostructures 124 of the second structured surface is pre-located accurately based on the location marker 113, thus the position distribution of the array of nanostructures 124 and the shape of nanostructures 124 to be manufactured of the second structured layer 121 are determined accurately.

Then according to the position distribution of the array of nanostructures 124 and the shape of nanostructures 124 to be manufactured, the photoresist 122 is exposed and developed again, so that the pattern of the residual photoresist just constitutes the pattern of the array of nanostructures 124 obtained by the target, or the complementary pattern of the array of nanostructures 124 obtained by the target (if the area of the alignment window 123 is excluded). Then the portion of the second structured layer exposed to the photoresist 122 is etched, that is, an array of nanostructures 124 located above the upper surface of the structured surface manufactured previously.

Then the residual photoresist 122 is removed, and the second structured surface 12 is obtained after the second filler material 125 is filled between the array of nanostructures 124 and the location marker.

FIG. 14 shows a schematic diagram of the obtained structure after polishing the upper surface of the second structured surface 12 in an embodiment of this application. As shown in FIG. 14, in one embodiment, for the array of nanostructures 124 in the second structured surface 12, after filling the second filler material 125, the upper surface of the second structured surface 12 is thinned and polished, so that the distance between the upper surface of the second structured surface 12 and the upper surface of the array of nanostructures 124 is less than or equal to pre-set threshold, thus the upper surface of the second structured surface 12 has a high plainness.

In one embodiment, the filler material to be filled includes a silica dioxide (SiO₂), alumina (Al₂O₃), titanium dioxide (TiO₂).

In one embodiment, the structured layers to be manufactured includes a silicon nitride (Si₃N₄), poly-crystalline silicon (Poly), titanium dioxide (TiO₂), alumina (Al₂O₃), silicon dioxide (SiO₂), indium tin oxide (ITO), niobium oxide (Ni₂O₅), magnesium fluoride (MgF₂).

In one embodiment, after lithographing and etching the structured layer, the obtained array of the nanostructures in the structured surface may be positive nanostructures, or the obtained array of the nanostructures in the structured surface may be negative nanostructures.

In one embodiment, the positive nanostructures refer to the nanostructures consisting of the residual nanostructured layer after etching; in this situation, the pattern of the residual photoresist after lithographing and etching and the pattern of the nanostructures consisting of the residual nanostructured layer after etching are the same. The negative nanostructures refer to the nanostructures consisting of the removed nanostructured layer after etching. In this situation, the pattern of the residual photoresist after lithographing and etching and the pattern of the residual structured layer after etching are complementary.

If the array of positive nanostructures obtained by etching, the pattern of the residual photoresist after exposing and developing the photoresist, the pattern of the residual photoresist will be complementary patterns with the pattern of the array of nanostructures. Therefore, the structured layer according to the residual photoresist, the array of positive nanostructures with the same pattern is obtained by etching. If the array of negative nanostructures is obtained by etching, the pattern of the residual photoresist after exposing and developing the photoresist, the pattern of the residual photoresist will be complementary patterns with the pattern of the array of nanostructures. Therefore, the structured layer according to the residual photoresist, the array of negative nanostructures with the same pattern is obtained by etching.

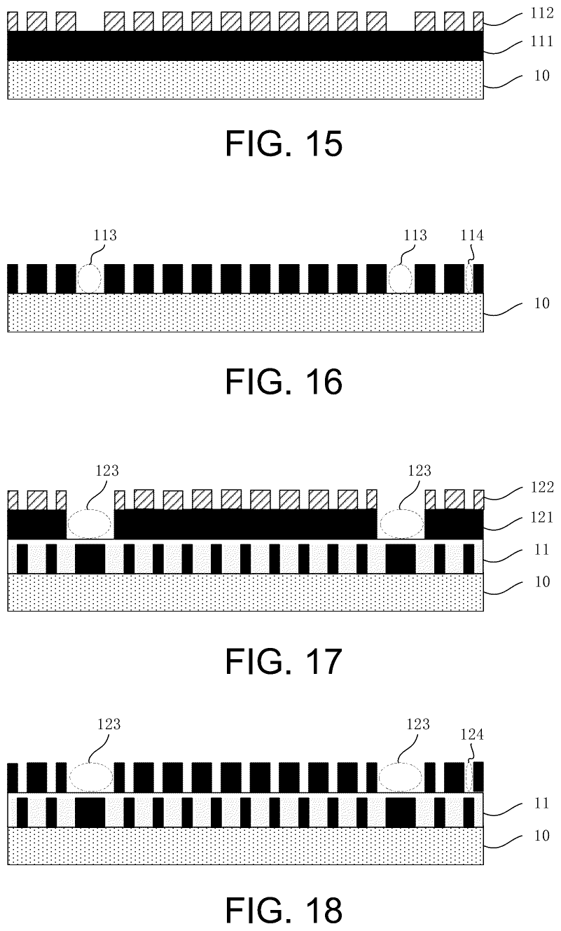

FIG. 15 shows a schematic diagram of the obtained structure after the lithography of array of negative nanostructures in the first structured layer 111. FIG. 16 shows a schematic diagram of the obtained structure after etching the array of negative nanostructures in the first structured layer 111.

As shown from FIG. 15 to FIG. 16, in the present embodiment, similar to the array of negative nanostructures, the location marker 113 to be manufactured in the first structured surface is the negative structure. In this situation, after manufacturing the first structured layer 111, the upper surface of the first structured layer 111 is coated with the photoresist 112. Therefore, the photoresist 112 is exposed and developed according to the obtained location distribution and the array of nanostructures 114, and the shape of the nanostructures 114, so that the pattern of the residual photoresist 112 just constitutes the pattern of the array of nanostructures 114 obtained by the target, or the complementary pattern of the array of nanostructures 114 obtained by the target. Then the portion of the Mₜₕ structured surface exposed to the photoresist 112 is etched, that is, an array of negative nanostructures 114 and the negative location marker 113 located above the upper surface of the structured surface manufactured previously.

In one embodiment, in the N structured surfaces in the multi-layer metalens, there is at least one structured surface consisting of positive nanostructures, and there is at least one structured surface consisting of negative nanostructures.

Because the dispersion curve of positive nanostructures has the opposite trend with the dispersion curve of negative nanostructures, it is beneficial to realize the chromatic aberration compensation of the multi-layer metalens by setting the multiple structured surfaces with positive and negative nanostructures.

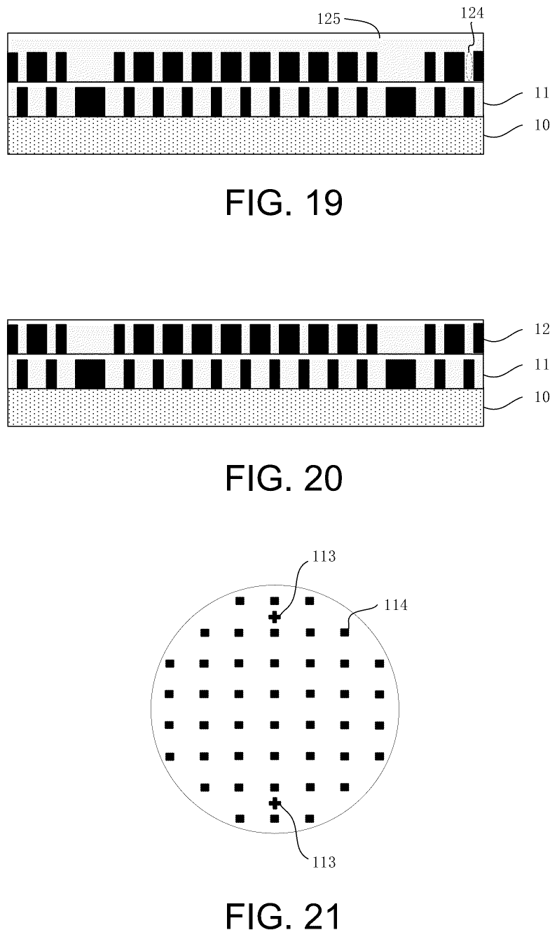

FIG. 17 shows a schematic diagram of the obtained structure after the lithography of the array of negative nanostructures 124 in the second structured layer 121. FIG. 18 shows a schematic diagram of the obtained structure after lithographing the array of negative nanostructures 124 in the second structured layer 121. FIG. 19 shows a schematic diagram of the obtained structure after filling the second filler material 125 in the array of negative nanostructures 124. FIG. 20 shows a schematic diagram of the obtained structure after polishing the array of negative nanostructures 124 on the upper surface of the second structured surface 12.

As shown from FIG. 3 to FIG. 10, and the description above from FIG. 3 to FIG. 10, the first structured surface 11 with the array of the nanostructures 114 is composed of positive structures. Further, referring to FIG. 17 to FIG. 20, in one embodiment, a first structured surface 11 with the array of nanostructures 114 consisting of positive nanostructures have been manufactured, a second structured layer 121 has also been manufactured on the first structured surface 11, and the alignment window 123 has also been manufactured on the second structured layer 121.

Therefore, through the alignment window 123, based on the location marker 113, the array of nanostructures 124 to be manufactured is pre-located accurately. Then according to the position distribution of the array of nanostructures 124 and the shape of nanostructures 124 to be manufactured, the residual photoresist 122 after manufacturing the alignment window 123 is exposed and developed again, so that the pattern of the residual photoresist 122 just constitutes the pattern of the array of nanostructures obtained by the target, or the complementary pattern of the array of nanostructures obtained by the target when the area of the alignment window 123 is excluded. Then the portion of the second structured layer 121 exposed to the photoresist 122 is etched, that is, an array of negative nanostructures 124 located above the upper surface of the structured surface manufactured previously.

Then the second filler material 125 is filled between the array of the negative nanostructures 124, therefore the second structured surface 12 is obtained. Then the upper surface of the second structured surface 12 is thinned and polished, so as to obtain the multi-layer metalens as shown in FIG. 20.

As shown in FIG. 20, the multi-layer metalens includes two structured surfaces. The array of nanostructures in the first structured surface 11 consists of the positive nanostructures, and the array of nanostructures in the second structured surface 12 consists of the negative nanostructures.

In one embodiment, “manufacturing the alignment window based on the marker location in the structured surface manufactured previously” includes: manufacturing the alignment window based on the marker location in the first structured surface. A projection of the location marker of the structured surface manufactured previously on a parallel surface of the wafer is located inside a projection of the alignment window in the structured surface manufactured previously on a parallel surface of the wafer.

In one embodiment, “through the alignment window, manufacturing the Mₜₕ structured surface based on the location marker of the structured surface manufactured previously” includes: through the alignment window, manufacturing the Mₜₕ structured surface based on the location marker of the first structured surface.

Specifically, in one embodiment, in the N structured surfaces in the multi-layer metalens, only the location marker needs to be manufactured in the first structured surface 11. Therefore, when manufacturing the Mₜₕ structured surface, according to the position distribution and shape of the location marker 113 in the first structured surface 11, the alignment window is manufactured.

The projection of the location marker of the first structured surface on a parallel surface of the wafer is located inside a projection of the alignment window in manufactured structured surface on a parallel surface of the wafer. That is, the alignment window matches with the location marker 113 of the first structured surface 11 in the perpendicular direction, and the shape of the location marker 113 is less than the alignment window.

Therefore, through the alignment window, the location marker 113 of the first structured surface 11 is located accurately. In this way, based on the location marker 113, the Mₜₕ structured surface is manufactured, so that the position of array of nanostructures in the Mₜₕ structured surface matches with the position of array of nanostructures 114 in the first structured surface 11.

Since except for the first structured surface 11 in the present embodiment, each structured surface doesn't need to have location marker, the present embodiment can improve the manufacturing speed of the multi-layer metalens effectively.

It should be noted that if each structured surface doesn't have location marker except for the first structured surface 11, with the increasing of M, the thickness between the alignment window in the Mₜₕ structured surface and the location marker of the first structured surface 11 will accumulate gradually. Thus, the location marker 113 is located through the alignment window. It is understandable that the greater the accumulation of location deviation for the location marker 113, the more significant the position deviation will be between the arrays of nanostructures of the first structured surface and the arrays of nanostructures of the Mₜₕ structured surface.

Therefore, to restrain accumulation the location deviation layer by layer as far as possible, in one embodiment, “manufacturing the alignment window based on the location marker of the structured surface manufactured previously” includes: manufacturing the alignment window based on the location marker of the structured surface manufactured previously; wherein the projection of the location marker of the structured surface manufactured previously is located inside the projection of the alignment window on the parallel surface of the wafer.

In the present application, through the alignment window, “manufacturing Mₜₕ structured surface based on the location marker of the structured surface manufactured previously” includes: through the alignment window, manufacturing the Mₜₕ structured surface based on the location marker of the M−1ₜₕ structured surface; wherein when M<N, the Mₜₕ structured surface further includes the location marker.

Specifically, in the present embodiment, in N structured surfaces of the multi-layer metalens, except for the Nₜₕ structured surface manufactured finally doesn't have the location marker, other structured surfaces have been manufactured with location markers. Therefore, when the Mₜₕ structured surface is manufactured, according to the position distribution and shape of the location marker of the M−1ₜₕ structured surface, the alignment window is manufactured.

The projection of the location marker of the first structured surface on a parallel surface of the wafer 10 is located inside a projection of the alignment window in manufactured structured surface on a parallel surface of the wafer 10. That is, the alignment window matches with the location marker 113 of the first structured surface 11 in the perpendicular direction, and the shape of the location marker 113 is less than the alignment window.

Therefore, through the alignment window, the location marker of the M−1ₜₕ structured surface is located accurately. Then based on the location marker of the M−1ₜₕ structured surface, the Mₜₕ structured surface is manufactured, so that position of the array of nanostructures in the Mₜₕ structured surface matches with the position of the array of nanostructures in the M−1ₜₕ structured surface.

Therefore, in the present application, except for the Nₜₕ structured surface manufactured finally, all other structured surfaces have location marker, even with the increasing of M, the thickness between the alignment window in the Mₜₕ structured surface and the location marker of the M−1ₜₕ structured surface will not accumulate. Therefore, when locating the location marker of the structured surface of the previous manufactured layer through the alignment window, the location deviation will not be accumulated layer by layer significantly, due to the increasing of M.

Therefore, this embodiment effectively suppresses the layer-by-layer accumulation of localization deviations, thus improving the control accuracy of the relative positions between the positions of arrays of nanostructures in different structured surfaces.

In one embodiment, in N structured surfaces of multi-layer metalens, except for the Nₜₕ structured surface manufactured finally, other structured surfaces all have location markers. Moreover, the projections in the structured surfaces on the parallel surface of the wafer 10 will not overlap.

In one embodiment, for the Mₜₕ structured surface, when locating the location marker of the structured surface manufactured previously through the alignment window, it will not be disturbed by the location marker of the Tₜₕ structured surface by controlling the location marker of each structured surface does not overlap with each other. The Tₜₕ structured surface is located in front of the M−1ₜₕ structured surface.

For example, when M=4, T=2 or 1. That is, for the fourth structured surface, when locating the location marker of the third structured surface through the alignment window, it will not be disturbed by the location marker of the second structured surface 12 and the location marker 113 of the first structured surface 11.

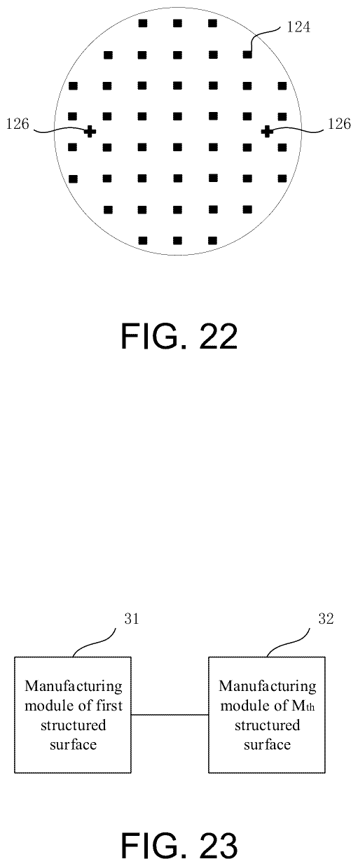

FIG. 21 shows a top view of the first structured surface 11 provided by the present application. FIG. 22 shows a top view of the second structured surface 12 provided by the present application.

As shown from FIG. 21 to FIG. 22, in one embodiment, for the multi-layer metalens, there are two location markers 113 of the first structured surface 11, and there are two location markers 126 of the second structured surface 12.

When observing the first structured surface 11 from a specific orientation, the two location markers 113 are arranged up and down. When the second structured surface 12 is viewed from the same orientation, the two location markers 126 of the second structured surface 12 are arranged left and right.

It can be seen that the projection of the location marker 113 of the first structured surface 11 on the parallel surface of the wafer 10 will not overlap with the projection of the location marker 126 on the second structured surface 12 on the parallel surface of the wafer 10. Therefore, when the third structured surface is manufactured, through the alignment window, the location marker 126 of the second structured surface 12 is located, it is not distributed by the location marker 113 of the first structured surface 11.

A multi-layer metalens is provided by the present application. As shown in FIG. 1 and the description of FIG. 1, the specific structural details of the multi-layer metalens provided in this application will not be described here. The multi-layer metalens provided in this application is manufactured by the method provided in any of the above method embodiments. Referring to any of the above embodiments of the manufacturing method, the specific implementation details of the multi-layer metalens provided in this application are not described here.

FIG. 23 shows a block diagram of a manufacturing device for a multi-layer metalens provided in the present application. The multi-layer metalens provided in the present application the multi-layer metalens includes a plurality of N structured surfaces arranged in a vertical direction on one surface of a wafer, N≥2; the manufacturing device includes:

A manufacturing module of the first structured surface 31, the manufacturing module of the first structured surface is configured to manufacture the first structured surface on the target surface of the wafer when the first structured surface to be manufactured; wherein the first structured surface includes the array of nanostructures and location marker;

A manufacturing module of the Mₜₕ structured surface 32, the manufacturing module of the Mₜₕ structured surface is configured to manufacture an alignment window based on the location marker manufactured previously; and through the alignment window, manufacturing the Mₜₕ structured surface based on the location marker of the structured surface manufactured previously; the Mₜₕ structured surface includes a plurality of nanostructures; and the plurality of nanostructures are arranged in an array; the array of nanostructures in the Mₜₕ structured surface matches with the array of nanostructures in the M−1ₜₕ structured surface; M≤N, and M>1.

In one embodiment, the manufacturing module of the Mₜₕ structured surface 32 is configured to manufacture the alignment window of the Mₜₕ structured surface based on the location marker of the M−1ₜₕ structured surface; through the alignment window, based on the location marker to manufacture the Mₜₕ structured surface. A projection of the location marker of the structured surface manufactured previously on a parallel surface of the wafer is located inside a projection of the alignment window of the structured surface manufactured previously on a parallel surface of the wafer.

In one embodiment, the manufacturing module of the Mₜₕ structured surface 32 is configured to manufacture the alignment window based on the location marker of the manufactured M−1ₜₕ structured surface; wherein the projection of the location marker of the M−1ₜₕ structured surface on the parallel surface of the wafer is located inside the projection of the alignment window of the parallel surface of the wafer;

through the alignment window, the manufacturing module of the first structured surface 31 is configured to manufacture the Mₜₕ structured surface based on the location marker of the structured surface manufactured previously; when M<N, the Mₜₕ structured surface further includes a location marker.

In one embodiment, the projections of the location markers in the structured surfaces on the parallel surface of the wafer will not overlap with each other.

In one embodiment, the manufacturing module of the first structured surface 31 is configured to manufacture the first structured surface on the target surface of the wafer, and lithography and etch the first structured surface, so as to obtain the array of nanostructures and location marker on the target surface;

and the manufacturing module of the first structured surface 31 is configured to fill a first filler material between the nanostructures and the location marker to obtain the first structured layer.

In one embodiment, the manufacturing module of the Mₜₕ structured surface 32 is configured to manufacture the Mₜₕ structured surface based on the location marker of the manufactured M−1ₜₕ structured surface, and lithograph and etch the Mₜₕ structured surface to obtain the alignment window;

through the alignment window, the manufacturing module of the Mₜₕ structured surface 32 is configured to pre-locate the array of nanostructures to be manufactured in the Mₜₕ structured surface based on the location marker of the structured surface manufactured previously;

and the manufacturing module of the Mₜₕ structured surface 32 is configured to fill an Mₜₕ filler material between the nanostructures on the M−1ₜₕ structured surface to obtain the Mₜₕ structured layer.

In one embodiment, the manufacturing device provided by the present application is configured to thin and polish an upper surface of the obtained structured surface after filling.

In one embodiment, after lithographing and etching the structured surface, the obtained nanostructures on the structured surface are positive nanostructures. In one embodiment, after lithographing and etching the structured surface, the obtained nanostructures on the structured surface are negative nanostructures.

This application also provides an electronic device. The electronic device is in the form of a universal computing device. The components of an electronic device may include, but are not limited to, at least one processor, at least one memory, and a bus connecting different system components (including memory and processor). The processor may include each of the modules in the apparatus as shown in FIG. 23.

The memory is stored with a program code, which may be executed by the processor, causing the processor to perform the steps of the exemplary embodiments described in the various exemplary embodiments described above. For example, the processor may perform each of the steps of the manufacturing method as shown in FIG. 2.

The memory may include readable media in the form of volatile memory, such as random access memory (RAM) and/or cache memory, and may further include a read-only memory (ROM).

The memory may also include a program/utility having a set of (at least one) of program modules including, but not limited to, the operating system, one or more applications, other program modules, and program data, each or some combination of these examples may include an implementation of a network environment.

A bus may be a local bus representing one or more of several types of bus structures, including a memory bus or memory controller, peripheral bus, graphics acceleration port, processor, or using any bus structure in a variety of bus structures.

The present application also provides a computer readable storage medium storing computer readable instructions that cause the computer to execute the manufacturing method provided by any of the manufacturing method embodiment when executed by the processor of the computer.

The above is only a specific embodiment of the embodiment of this disclosure, but the scope of protection of the embodiment of this disclosure is not limited to this, any person familiar with the scope of the change or substitution, should be covered within the protection scope of the embodiment of this disclosure. Therefore, the scope of the protection of the present disclosure shall depend to the scope of the claim.

What is claimed is:

1. A manufacturing method of a multi-layer metalens, wherein the multi-layer metalens comprises a plurality of N structured surfaces arranged in a vertical direction on one surface of a wafer, N≥2;
the manufacturing method comprises:
when a target surface to be manufactured is a first structured surface, manufacturing the first structured surface on a target surface of the wafer; the first structured surface comprises a plurality of nanostructures and a location marker; and the plurality of nanostructures are arranged in an array;
when the target surface to be manufactured is an Mₜₕ structured surface, manufacturing an alignment window based on the location marker of the structured surface manufactured previously; and through the alignment window, manufacturing the Mₜₕ structured surface based on the location marker of the structured surface manufactured previously;
wherein the Mₜₕ structured surface comprises a plurality of nanostructures; and the plurality of nanostructures are arranged in an array;
a position of the array of nanostructures in the Mₜₕ structured surface matches with a position of the array of nanostructures in the structured surface manufactured previously in a perpendicular direction; M≤N, and M>1.

2. The manufacturing method of claim 1, wherein “manufacturing an alignment window based on the location marker of the structured surface manufactured previously” comprises:
manufacturing the alignment window based on the location marker of the first structured surface; wherein a projection of the location marker of the first structured surface on a parallel surface of the wafer is located inside a projection of the alignment window on a parallel surface of the wafer;
“through the alignment window, manufacturing the Mₜₕ structured surface based on the location marker of the structured surface manufactured previously” comprises: through the alignment window, manufacturing the Mₜₕ structured surface based on the location marker of the first structured surface.

3. The manufacturing method of claim 1, wherein “manufacturing the alignment window based on the location marker of the structured surface manufactured previously” comprises:
manufacturing the alignment window of the Mₜₕ structured surface based on the location marker of the M−1ₜₕ structured surface; wherein a projection of the location marker of the M−1ₜₕ structured surface on a parallel surface of the wafer is located inside a projection of the alignment window on a parallel surface of the wafer;
“through the alignment window, manufacturing the Mₜₕ structured surface based on the location marker of the structured surface manufactured previously” comprises: through the alignment window, manufacturing the Mₜₕ structured surface based on the location marker of the M−1ₜₕ structured surface; wherein, when M<N, the Mₜₕ structured surface further comprises a location marker.

4. The manufacturing method of claim 3, wherein the projections of the location markers of the structured surfaces on the parallel surface of the wafer don't overlap with each other.

5. The manufacturing method of claim 1, wherein “manufacturing the first structured surface on a target surface of the wafer” comprises:
manufacturing a first structured layer on the target surface, and lithographing and etching the first structured layer, so as to obtain the array of nanostructures and the location marker on the target surface;
filling a first filler material between the adjacent nanostructures, and between the nanostructures and the location marker on the target surface to obtain the first structured surface.

6. The manufacturing method of claim 1, wherein “manufacturing an alignment window based on the location marker of the structured surface manufactured previously” comprises:
manufacturing an Mₜₕ structured layer on the upper surface on the M-1ₜₕ structured surface, and lithographing and etching the Mₜₕ structured layer to obtain the alignment window;
“through the alignment window, manufacturing the Mₜₕ structured surface based on the location marker of the structured surface manufactured previously” comprises:
through the alignment window, pre-locating the array of nanostructures to be manufactured in the Mₜₕ structured layer based on the location marker of structured surface manufactured previously;
based on the pre-location of the array of nanostructures in the Mₜₕ structured surface, lithographing and etching the Mₜₕ structured layer, so as to obtain the array of nanostructures on the upper surface of the M−1ₜₕ structured surface;
filling an Mₜₕ filler material between the arrays of nanostructures on the upper surface of the M−1ₜₕ structured surface, so as to obtain the Mₜₕ structured surface.

7. The manufacturing method of claim 5, wherein after filling a filler material to obtain the corresponding structured surface, the manufacturing method comprises:
thinning and polishing an upper surface of the obtained corresponding structured surface.

8. The manufacturing method of claim 6, wherein after filling a filler material to obtain the corresponding structured surface, the manufacturing method comprises:
thinning and polishing an upper surface of the obtained corresponding structured surface.

9. The manufacturing method of claim 5, wherein after lithographing and etching the structured layer, the obtained nanostructures on the structured layer are positive nanostructures.

10. The manufacturing method of claim 6, wherein after lithographing and etching the structured layer, the obtained nanostructures on the structured layer are positive nanostructures.

11. The manufacturing method of claim 5, wherein after lithographing and etching the structured layer, the obtained nanostructures in the structured layer are negative nanostructures.

12. The manufacturing method of claim 6, wherein after lithographing and etching the structured layer, the obtained nanostructures in the structured layer are negative nanostructures.

13. A manufacturing device, wherein the multi-layer metalens comprises an N structured surfaces arranged in a vertical direction on the same surface of a wafer, N≥2;
a manufacturing module of the first structured surface, the manufacturing module of the first structured surface is configured to manufacture the first structured surface on a target surface of the wafer, when the target surface to be manufactured is the first structured surface; wherein the first structured surface comprises the array of nanostructures and location marker;
a manufacturing module of the Mₜₕ structured surface, the manufacturing module of the Mₜₕ structured surface is configured to manufacture an alignment window based on the location marker of the structured surface manufactured previously; and through the alignment window, to manufacture the Mₜₕ structured surface based on the location marker of the structured surface manufactured previously; the Mₜₕ structured surface comprises a plurality of nanostructures, and the plurality of nanostructures are arranged in an array; a position of the array of nanostructures in the Mₜₕ structured surface matches with a position of the array of nanostructures in the M−1ₜₕ structured surface in the perpendicular direction; M≤N, and M>1.

14. A multi-layer metalens, wherein the multi-layer metalens is obtained by using the manufacturing method claimed as claim 1.

15. The multi-layer metalens of claim 14, wherein the multi-layer metalens comprises an N structured surfaces arranged in a vertical direction on the same surface of a wafer, N≥2;
the N structured surfaces comprise: the first structured surface, the second layer, . . . , the Nₜₕ structured surface; the first structured surface comprises the plurality of nanostructures and the location marker, and the plurality of nanostructures are arranged in an array;
the Mₜₕ structured surface comprises an alignment window, and the alignment window corresponds to the location marker of the structured surface manufactured previously;
the Mₜₕ structured surface comprises a plurality of nanostructures, and the plurality of nanostructures are arranged in an array;
a position of the array of nanostructures in the Mₜₕ structured surface matches with a position of the array of nanostructures in the M−1ₜₕ structured surface in a perpendicular direction; M≤N, and M>1.

16. The multi-layer metalens of claim 15, wherein a projection of the location marker of the structured surface manufactured previously on a parallel surface of the wafer is located inside a projection of the alignment window in the structured surface manufactured previously on a parallel surface of the wafer.

17. The multi-layer metalens of claim 15, wherein a projection of the location marker of the structured surface manufactured previously on a parallel surface of the wafer is located inside a projection of the alignment window in the structured surface manufactured previously on a parallel surface of the wafer;
wherein, when M<N, the Mₜₕ structured surface further comprises a location marker.

18. The multi-layer metalens of claim 17, wherein the projections of the location markers in the structured surfaces on the parallel surface of the wafer don't overlap with each other.

19. An electronic device, the electronic device comprises: a bus, a transceiver, a memory, a processor and a computer program;
wherein the computer program is stored in the memory and executable on the processor; the transceiver, the memory and the processor are connected through the bus; the computer program is executed by the processor, so as to implement the manufacturing method of claim 1.

20. A non-transitory computer-readable storage medium, the non-transitory computer-readable storage medium in which a computer program is stored, wherein the computer program is executed by a processor, so as to implement the manufacturing method of claim 1.
